(19) United States
(12) Patent Application Publication
(10) Pub. No.: US 2018/0065427 A1
(43) Pub. Date: Mar. 8, 2018

(54) SYSTEMS AND METHODS FOR OPTIMIZING THE BALANCE OF BICYCLE WHEELS

(71) Applicant: STIRRED NOT SHAKEN, LLC, MERCER ISLAND, WA (US)

(72) Inventor: DANIEL SOTELO, MERCER ISLAND, WA (US)

(21) Appl. No.: 15/493,054

(22) Filed: Apr. 20, 2017

Related U.S. Application Data
(60) Provisional application No. 62/325,329, filed on Apr. 20, 2016.
(60) Provisional application No. 62/368,272, filed on Jul. 29, 2016.

(51) Int. Cl. B60C 19/00; F16F 15/32

(52) U.S. Cl. CPC B60C 19/003; B60B 1/003; F16F 15/324

(57) ABSTRACT

The present disclosure is directed to methods and systems for optimizing the performance of bicycle-type wheels and wheel components. One example includes the manufacture, arrangement, and assembly of rims, tires, tubes and/or other components in a manner that results in an optimal smooth rotation with little or close to no oscillation and/or yaw by controlling, marking, and aligning the heavy spots inherently created during the production of such components. Other aspects of the present disclosure are directed to methods and systems for monitoring and alerting a user to imbalance of a wheel system, a rotational weight shifting wheel, and a valve-less tire.

### PRIORITY CLAIM

This application claims the benefit of U.S. Provisional Patent Application Ser. No. 62/325,329 filed Apr. 20, 2016 and No. 62/368,272 filed Jul. 29, 2016, each of which is incorporated by reference in its entirety as if fully set forth herein.

### COPYRIGHT NOTICE

This disclosure is protected under United States and/or International Copyright Laws. © 2017 Stirred Not Shaken, LLC. All Rights Reserved. A portion of the disclosure of this patent document contains material which is subject to copyright protection. The copyright owner has no objection to the facsimile reproduction by anyone of the patent document or the patent disclosure, as it appears in the Patent and/or Trademark Office patent file or records, but otherwise reserves all copyrights whatsoever.

### FIELD OF THE DISCLOSURE

The present disclosure relates generally to wheels and wheel components, and more specifically to the optimizing performance of bicycle-type wheels and wheel components.

### BACKGROUND

Bicycle wheel components, including but not limited to tires, tubes, and rims, are generally manufactured with an inherent heavy spot. These heavy spots can cause the assembled wheel to be imbalanced, which in turn causes the wheel to oscillate and yaw when turning at speed. This is not only uncomfortable for the ultimate end user, but also can result in safety and performance problems. Conventional wheel balancing techniques, if performed for the assembled wheel, have generally consisted of adding external rubber/metal or other types of weights to final and/or fully assembled wheels. These techniques have various shortcomings and disadvantages. Other recent trends have been to focus on the manufacture of a single wheel component: a near perfectly balanced rim. This approach has been costly and ineffective. Accordingly, there is a need for improvement in the field of bicycle-type wheel and wheel component manufacture and assembly.

### SUMMARY

Aspects of the present disclosure, either independently or working together, optimize the performance of bicycle-type wheel and wheel components.

Aspects of the present disclosure are directed to methods and systems for achieving optimal manufacture and arrangement of rims, tires, tubes and/or other components in a manner that results in an optimal smooth rotation with little or close to no oscillation and/or yaw. In these embodiments, the disclosed methods and systems modify the manufacture and/or arrangement of the heavy spots of the rims, tires, tubes and/or other components for an unprecedented degree of, in some cases, near perfect balance. For example, each component will be manufactured with heavy spots with weights and locations that are consistently known and marked, such that one with any skill in the art would be able to follow easy assembly guidelines to assemble a near perfectly balanced wheel. Other aspects of the present disclosure are directed at methods and systems directed to monitoring and alerting a user to imbalance of a wheel system; a rotational weight shifting wheel; and a valve-less tire.

### BRIEF DESCRIPTION OF THE DRAWINGS

FIG. 1 illustrates an example of an assembled wheel.

FIGS. 2A and 2B illustrate an example of an assembly guide logo placed on a tire.

FIGS. 3A and 3B illustrate an example of a rim.

FIG. 3C illustrates various examples of joining inserts used to manufacture a rim.

FIG. 4 illustrates examples of average heavy spots corresponding to different wheel components.

FIG. 5A illustrates multiple positions of wheel components aligned to provide a balanced assembled wheel.

FIG. 5B illustrates an example of an assembled wheel using the assembly guide logo.

FIG. 6A illustrates another example of a rim.

FIG. 6B illustrates a cross-sectional view of the rim depicted in FIG. 6A.

FIG. 7 illustrates an example of a wheel with additional wheel components.

FIG. 8 illustrates another example of a wheel with additional wheel components.

FIG. 9 illustrates example of a wheel with wheel yaw correction.

FIG. 10 illustrates an example of a wheel without an air valve.

### DETAILED DESCRIPTION

Systems and methods are described for manufacturing and/or assembling a wheel with improved balance. It is to be understood that the use of absolute terms, such as “must,” “will,” and the like, as well as specific quantities, is to be construed as being applicable to one or more of such embodiments, but not necessarily to all such embodiments. As such, embodiments of the disclosure may omit, or include a modification of, one or more features or functionalities described in the context of such absolute terms. In addition, the headings in this application are for reference purposes only and shall not in any way affect the meaning or interpretation of the present disclosure. In some cases, embodiments or examples, or aspects thereof, of the present disclosure may be combined. As used herein:

“bicycle” or “bicycle-type” shall collectively refer to all types and categories of unicycles, bicycles, tricycles, quadracycles, and the like, regardless of function (racing, recreation, etc.); number of riders (one, two, or more); construction or frame type (upright, folding, etc.); gearing (single speed, derailleur gears, etc.); sport (mountain biking, BMX, triathlon, etc.); means of propulsion (human-powered, motor-assisted, etc.); or rider position (upright, recumbent, etc.); or other miscellaneous types such as pedicabs, rickshaws, and clown bikes;

“wheel” shall refer to the assembled product of various wheel components;

“rim” shall refer to the hard component of a wheel which holds the tire;

“tire” shall collectively refer to all types of round rubber sheaths mounted inside the outer edge of the rim, including but not limited to pneumatic tires and tubeless tires;

“tube” shall refer to the inner inflatable rubber balloon contained in a pneumatic tire and generally comes with an air inflation valve;

“tubeless valve” shall refer to an air inflation valve which is attached to the rim and does not have a tube (round rubber balloon) attached to it; and

“default” or “heavy spot” refer to the spot on the tire, tube or rim that is heavier at that spot than the average weight of all other spots on the circumference of that component.

### Methods and Systems for Manufacture and Assembly

As mentioned above, uneven distribution of weight around the tube, tire, rim, and/or wheel assembly (also known as defaults or heavy spots) are normal. However, these heavy spots can cause the wheel to vibrate and/or oscillate, leading to safety, handling, and performance problems. Aspects of the present disclosure take the conventional production methods for, e.g., tires, tubes, and rims, which have a history of having inconsistent heavy spots, and modify the manufacturing process to control the consistency of heavy spots and their weights on each such component. As such, aspects of the present disclosure, either individually or in combination, achieve a superior and safer, high speed wheel balance. Moreover, an optionally advantageous feature of these aspects is that the methods and systems to control and modify the already existing heavy spots during production will add little or no cost to existing production methods, as opposed to current trending efforts by some in the industry to focus solely on the creation of a near balanced rim, which is neither cost effective nor production friendly. Furthermore, even if a near perfectly balanced rim is produced, for example using current methods, when the rim manufacturer mounts the tire and tube on a near perfectly balanced rim, the manufacturer will still have an unbalanced assembled wheel due to the heavy spots on the tire and/or tube.

Much of the status quo of bicycle-type wheel balancing is not to balance the assembled wheel at all. If any balancing is done at the stage of an assembled wheel, the common practice is to add external metal or other types of weights to gain some better balance effect. This solution is not ideal in some cases in light of today's ultra-light-weight bicycles and wheels. Moreover, externally added weights increase the danger that they could come loose and fall off, causing wheel oscillation while at speed. Aspects of the present disclosure will not add any additional metal weights or any other type of weights to achieve a near balanced wheel assembly. Rather, aspects of the present disclosure utilize the existing heavy spots in the wheel components to offset and achieve optimal balance, which is safer and more advantageous.

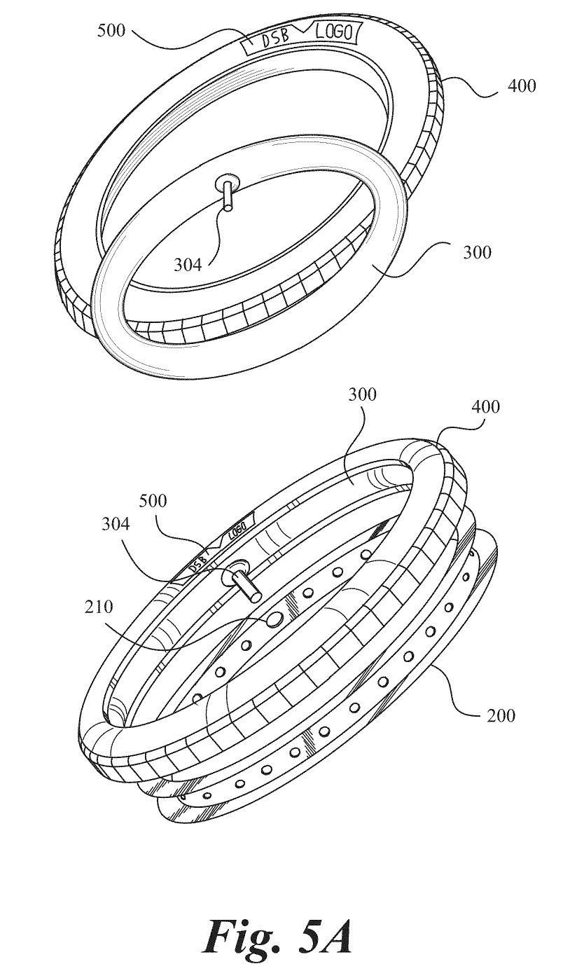

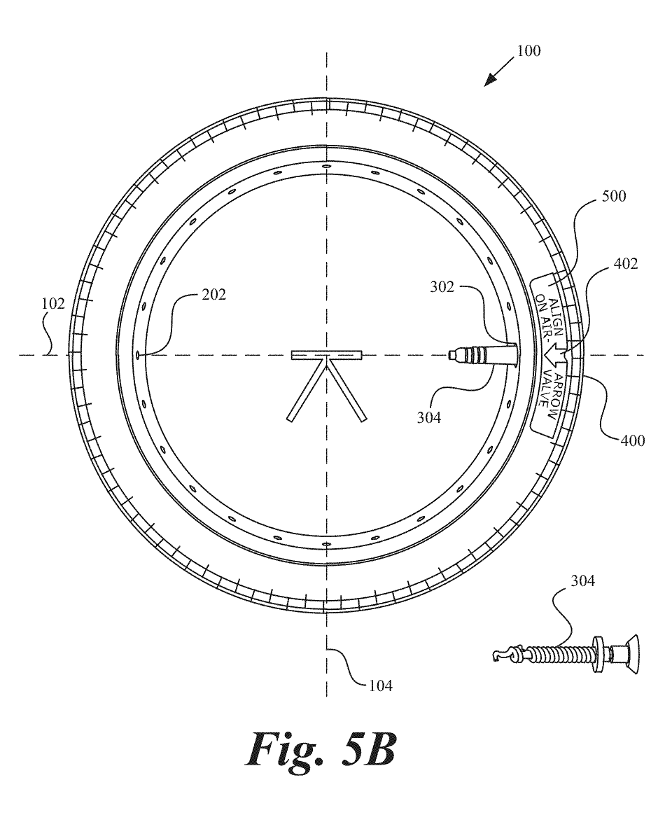

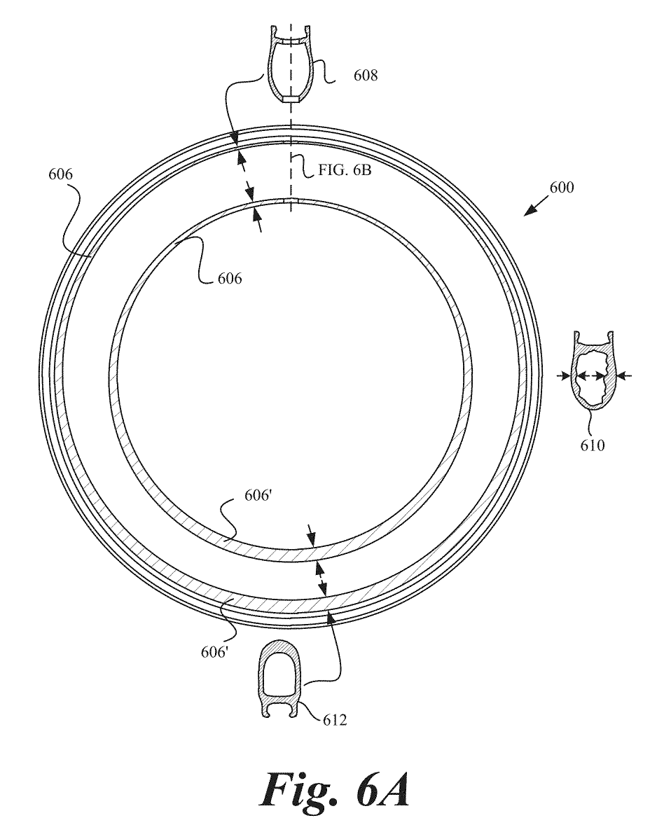

Another optionally advantageous feature of a preferred embodiment of the present disclosure is that elimination of any need for expertise or experience for the consumer, a bicycle-type or assembly shop, or even an OEM bicycle-type manufacture/assembler. With aspects of the present disclosure, one will not need any mechanical or technical knowledge to calculate, as in prior techniques, where to add or adjust external weights to wheels to achieve better balance. Rather, with the, e.g., assembly guide logos and other various and potential indicators illustrating the location and weight of light and/or heavy spots of one or more components, all that will be needed is to align the, e.g., assembly guide logo, as further depicted in FIGS. 5A and 5B. In some cases, the manufacturers of one or more wheel components may determine the location of the heavy spot and control the weight of the heavy spot to specific amounts and/or defined ranges.

As such, the modified manufacturing and assembly processes to control and mark the heavy spots of bicycle-type rims, tires, tubes and/or other components disclosed herein can attain the optimal balance of an assembled wheel such that there is minimal vibration and oscillation of the wheel during high speed rotation.

In one example, a preferred method and system uses various strategies, rules, specifications, tests, material, and formula to calculate and achieve a particular weight of the heavy spots of each wheel component. Then, this information is used to inform or determine a specific method of manufacture and assembly in order to attain the optimal balance of wheel components when assembled.

In one example, a manufacturer can control the weight of the heavy spot of the tire by adding or subtracting raw, un-vulcanized rubber before molding and producing the tire.

Then, for example, a manufacturer of the tube component can control the weight of the heavy spot of the tube at the valve juncture by using various materials (e.g., aluminum, brass, etc.), different amounts of thickness of materials (e.g., rubber), and/or lengths of the valve assembly.

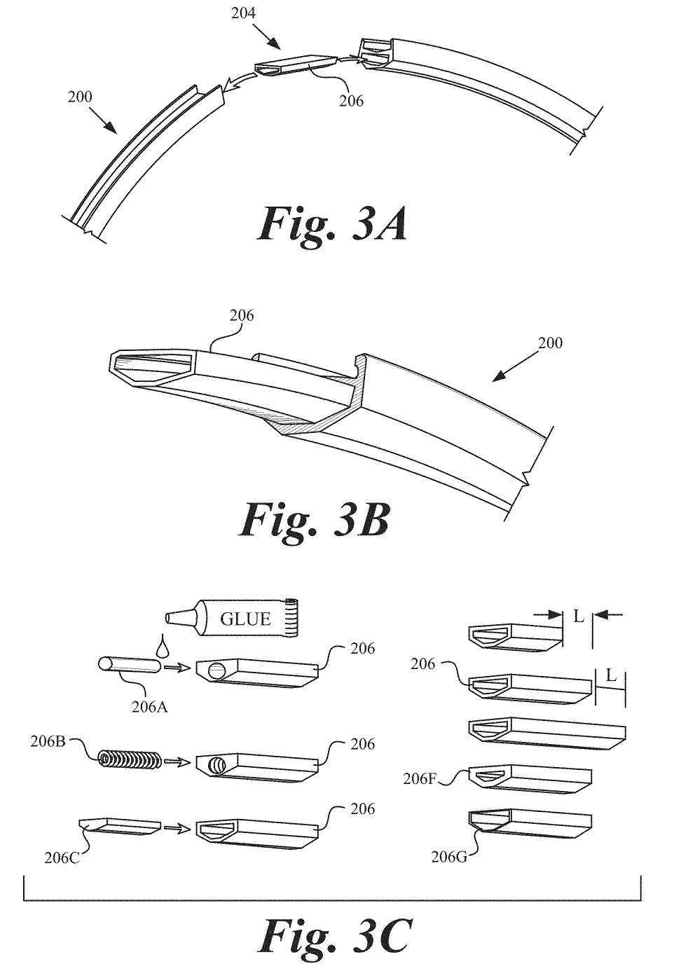

A rim manufacturer may additionally or alternatively control the weight of the heavy spot on the rim, typically where the rim is joined opposite of where the hole for the valve is drilled, by controlling the weight of the rim joint insert, as further illustrated in FIGS. 3A through 3C.

After the improved or near perfect balance achievement attained by using aspects of the present disclosure, the assembled wheel can be rotated at speed without significant oscillation forces occurring.

In one example, wheel components produced under the disclosed method and system can have controlled heavy spot weights: a tire with a heavy spot weight of 15 grams, a tube with a heavy spot weight of 5 grams, and a rim with a heavy spot weight of 20 grams. When the tire and tube are arranged with their heavy spots together using the disclosed assembly method, it creates a combined heavy spot of 20 grams. Again using the disclosed assembly method, the rim's 20 gram heavy spot can be arranged at the opposite side of the wheel directly across tire/tube combined heavy spot, creating a 50/50 balanced wheel assembly.

A number of factors can be taken into consideration when determining the defaults of manufacturing of the wheel components, including but not limited to tires, tubeless tires, tubes, valves, and rims. For example, in one embodiment, the heavy spots in tires are caused by the method of tire manufacture which generally includes the overlapping of fabric, rubber, and wire beads to complete the circle of the tire. In this embodiment, the heavy spots generally appear where these three materials overlap during the manufacturing process. In another embodiment, bicycle rubber inner tubes are usually extruded and then connected to form a circle. This process may not create significant heavy spots, but when an air valve is attached to the tube, the air valve can create a significant heavy spot for the inner tubes. In yet another embodiment, the heavy spots on metal rims are created when the extruded, bent metal is connected to form a circle. In this embodiment, to connect the circle, a plug can be inserted or a weld performed, both of which add extra weight. In this embodiment, it is this metal rim joining process that causes the heavy spot to be at the rim joint. In still another embodiment, carbon rims made of carbon fiber resin also yield heavy spots. In this embodiment, to cause the inside of the carbon fiber rim to be hollow during the manufacturing process, an inflatable air bladder is typically placed inside of the circle of carbon fiber resin which is in turn inside of a smooth mold. The bladder, when fully inflated, pushes the carbon fiber resin in unpredictable, inconsistent ways causing the thickness of the resin to be inconsistent around the carbon rim, as the resin in turn pushes against the smooth mold. This is a reason carbon rims have thin and thick walls around the rim in various places. Hence, heavy spots are inherent in this manufacturing process of carbon rims.

In general, it is a very costly manufacturing process to make each component of a wheel perfectly balanced. The described techniques use the defaults advantageously by making minor adjustments in the manufacturing process of each component and directing the assembly of the components, which give the result of a near perfectly balanced wheel. The described techniques cause very little, if any, extra cost to the manufacturing process and achieve a much better overall result than making near perfectly balance individual components.

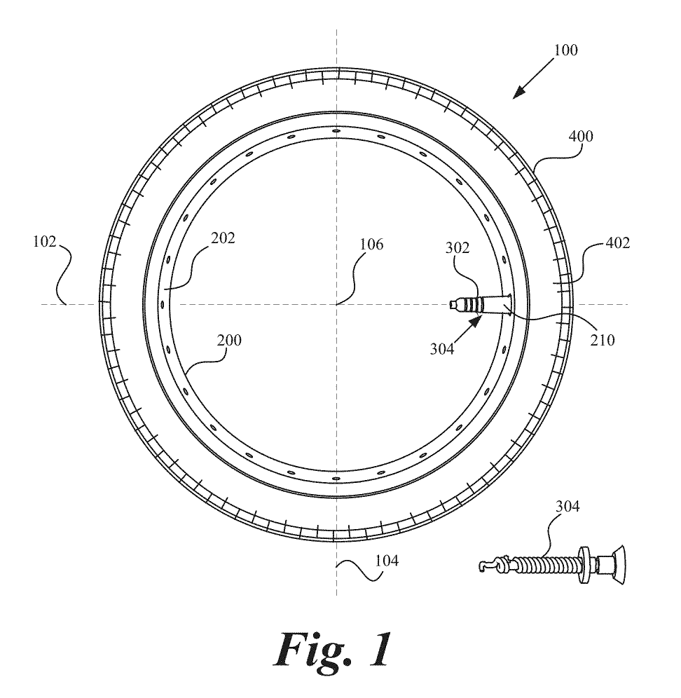

FIG. 1 illustrates an example of assembled wheel 100 and demonstrates the relationship of examples of heavy spots 202, 302, 402. Shown in FIG. 1 is a dotted x-axis 102 and y-axis 104 that intersect at the center 106 of the assembled wheel 100.

The rim heavy spot 202 is located at the spot where the rim 200 was joined together and is on one side of the x-axis 102 on the perimeter of the rim 200. On the opposite side of the x-axis 102 is the pneumatic tube heavy spot 302 which is where the pneumatic tube valve 304 of the pneumatic tube 300 (not shown here) is positioned through the hole 210 drilled in the rim 200. The tire heavy spot 402 will then be in the same position as the pneumatic tube heavy spot 302 directly across the rim heavy spot 202. In a different embodiment with a tubeless air valve 304′ assembly, the tubeless air valve 304′ would be in the same corresponding position as the pneumatic tube valve 304.

As illustrated in FIG. 1, the rim 200 and the tire 400 may be arranged and/or assembled in such as a way as to balance out extra weight of the rim heavy spot 202, tire heavy spot 402, and/or weight of the tube heavy spot 302/valve about the center of the wheel 106. In other examples, one or more of the tire 400, rim 200, and/or tube 300 may be oriented differently with respect to the other wheel components to balance the wheel, when, for example, one or more of these components have different weights associated with their respective heavy spots (e.g., where one or more of heavy spots 202, 302, or 402 are not aligned opposite each other about the center 106).

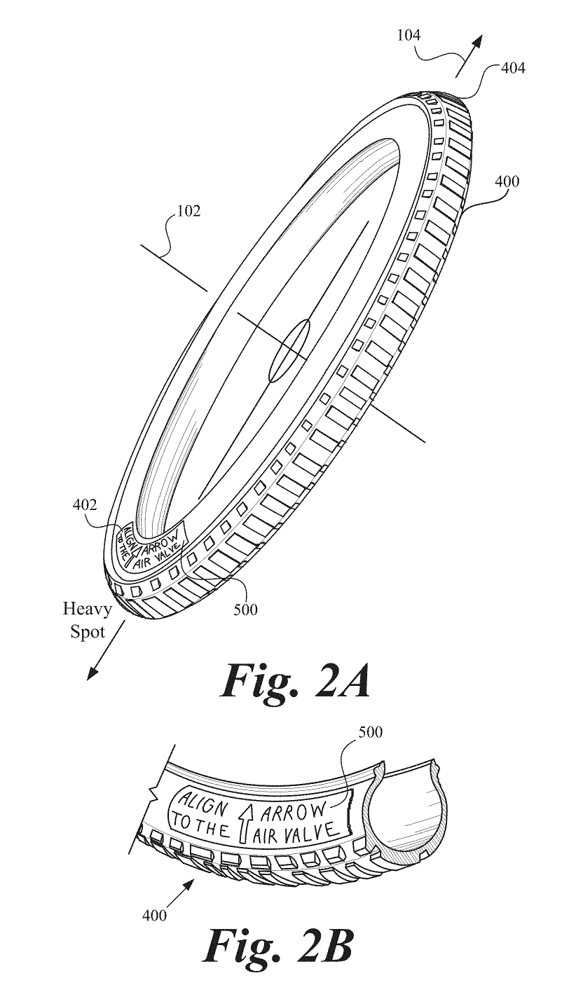

FIG. 2A illustrates an example of a tire 400 in which an assembly guide logo 500 is placed on the tire 400. FIG. 2B depicts one example of an assembly guide logo 500 added or molded onto tire 400. As shown in FIG. 2A, the assembly guide logo is added or molded onto the tire 400 in a position that aligns with the tire heavy spot 402. Opposite of the tire heavy spot 402 and assembly guide logo 500, in some cases, is the tire light spot 404. In some cases, the logo 500 may aid in aligning the tire 400 relative to the rim 200 to balance the wheel. In some examples, an assembly guide logo, or other marking may be positioned on the tire in other locations having a different weight than the rest of the tire or a part of the tire (e.g., a weight difference). In some cases, multiple markings may be included on the tire 400. In yet some examples, the marking may include an indication of the weight of the heavy spot.

FIG. 3A illustrates one example of a wheel component: the rim 200, the rim's joining point 204, and the joining insert 206. FIG. 3B depicts a magnified and cross sectional view of the joining insert 204 which is illustrated as being hollow.

FIG. 3C illustrates various examples of joining inserts 206 that can be used to increase or decrease the weight. For example, additional weight can be achieved by gluing a weight 206A, threading and screwing the weight 206B, or press-fitting a weight 206C into the joining insert 206. Reducing or adding weight can also be achieved by shortening or lengthening the joining insert 206 by a length of L. Yet another way of reducing or adding weight is by creating a thicker-walled joining insert 206F or a thinner-walled joining insert 206G.

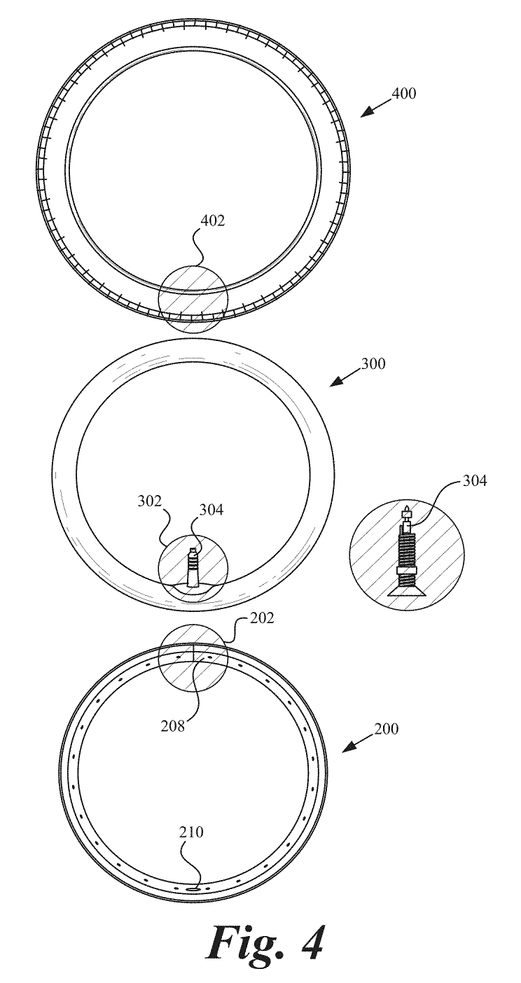

FIG. 4 illustrates examples of average heavy spots of different wheel components caused by their manufacture. FIG. 4 depicts three examples of wheel components: a tire 400, a pneumatic tube 300, and a rim 200. In one example, the tire heavy spot can average 1-40 grams, the pneumatic tube heavy spot 302 (located at pneumatic tube valve 304) can average 1-20 grams, and the rim heavy spot 202 (located at the rim joint 208) can average 1-60 grams. The hole 210 is located on the opposite side of the rim joint 208 and is where the pneumatic tube valve 304 will be located. The average range of 1-20 grams also applies to the tubeless air valve 304′ assembly. These average ranges are from actual weight measurements of components currently on the market.

FIG. 5A illustrates multiple positions of wheel components aligned to provide a balanced assembled wheel. An example process for aligning and assembling various wheel components, such as a rim 200, a tube 300, and tire 400, is provided below.

In one example, the recommended order for assembling the three wheel components is:

A. Partially inflate the rubber inner tube 300 so it holds its shape. In some cases, for example, where a tubeless tire is used, or in other cases, this operation may be optional.

B. Insert the partially inflated tube 300 into the tire 400 making sure to align the air valve 304 with the arrow in the tie logo 500 on the tire 400.

C. Mount the tire 400 and tube assembly onto the rim 200 with the air valve 304 through the valve hole 210 in the rim 200. This will automatically align the adjusted default weights to achieve near perfect rotational balance for the wheel. The tube 400/tubeless tire may then be inflated to full pressure to yield a more balanced wheel.

It should be appreciated that the above process for assembling a wheel is only given by way of example. In other cases, one bead of the tire 400 may be placed around the rim 200. In some cases, this may be performed by a bicycle manufacturer. Next, the tube 300 may be inserted at least partially into the tire 400, and the air valve 304 inserted through the hole 210 of the rim 200. In some cases, this may also be performed by the bicycle manufacturer. Next, or when the tire 400 is initially placed about the rim 200, the tire 400 may be aligned about the rim 200 such that the heavy spot 402 and/or logo 500 is placed at the hole 210 of rim 200. Next, the tube 300 may be partially inflated, and the other bead of the tire 400 placed inside and/or around the rim 200. The tube 300 may then be inflated to full operating pressure, thus resulting in a more balanced wheel.

One or both of the above described processes may be modified to accommodate a tubeless tire, as would be apparent by the present disclosure by those having ordinary skill in the art.

FIG. 5B illustrates an assembled wheel 100 of one example of the present disclosure by using the assembly guide logo 500. The assembly guide logo 500 is placed on the tire 400 at the tire heavy spot 402. The assembly guide logo 500 is aligned with the pneumatic tube air valve 304 (or tubeless air valve 304′), which is directly across from the rim heavy spot 202, which is the rim's joining point 208.

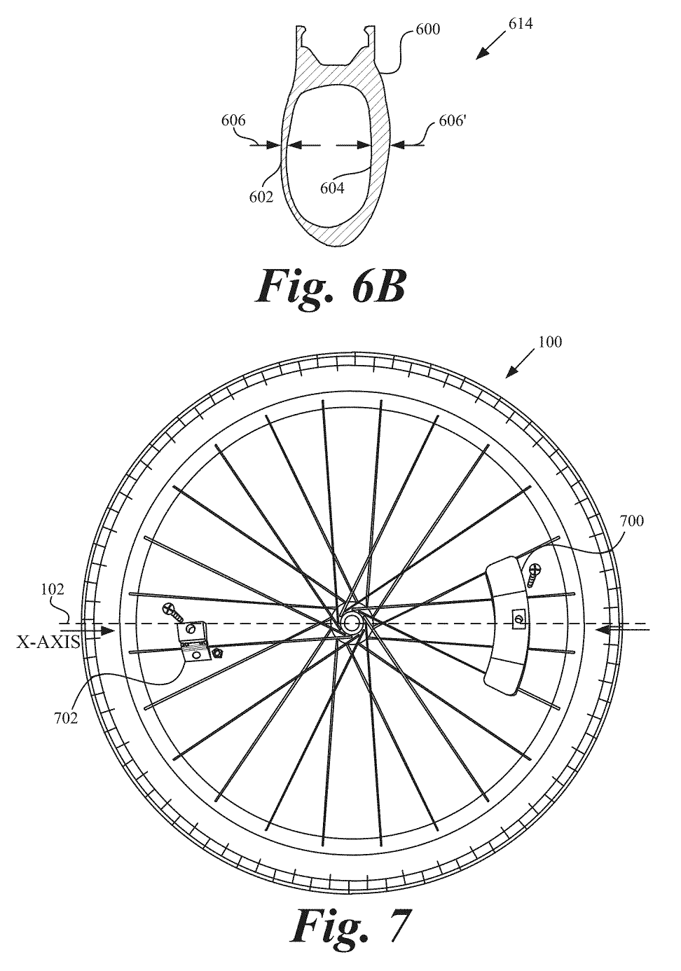

FIG. 6A illustrates a lateral circumference view of an example of a rim component 600 known as FRP rims or carbon fiber bicycle-type rims. One can still manufacture defaults in this type of rim component 600. FIG. 6A also includes a number of cross-sectional views 608, 610, and 612 of rim 600. FIG. 6B illustrates a more detailed cross-sectional view 614 of the rim component 600. In FIG. 6B, the outer surface 602 is smooth and even to specifications and the inner surface 604 may be uneven. The uneven inner surface 604 is caused by the inflatable molding bladder (not shown here), which creates thinner walls in some areas and thicker walls in other areas, thus causing a heavy spot (not shown here). The thinner walls 606 and thicker walls 606′ can also be observed in FIG. 6A.

In some aspects, although not depicted here, one skilled in the art would understand that once the heavy spot is detected, a hole can be drilled or cut directly across the heavy spot, which is where the air valve assembly would be inserted and joined, thus achieving the weight balancing results with this FRP molded rim component 600.

### Reflector Balancing

Most if not all new bicycle-type products sold in the United States must be equipped with reflectors as specified by the Consumer Products Safety Commission. Other state, local, and/or foreign rules and regulations may impose more or less rigorous reflector and/or lighting requirements. Hence, even with an optimally balanced wheel system manufactured and/or assembled using the disclosed methods and systems disclosed herein, once a reflector is added to the assembled wheel, the weight of a whole wheel will be uneven again, causing the same safety, discomfort, and performance problems as an unbalanced tube, tire, rim, and/or wheel. Accordingly, one aspect of the present disclosure utilizes and applies the general principles previously disclosed and achieves optimal balance in the assembled wheel even after a reflector is mounted. As illustrated in FIG. 7, this aspect includes a wheel 100 and a reflector 700 having a weight, which may be, for example, 20 grams. Directly opposite of the reflector 700 about the center of the wheel 100 is a counterweight 702 having the same weight as the reflector 700, which in this example, is 20 grams. One skilled in the art would appreciate that the reflector 700 can be controlled at any weight, and the counterweight 702 can be manufactured or incorporated directly in the wheel manufacture and assembly process.

In one example, the counterweigh 702 may be attached about one or more spokes of the wheel 100, for example, via a screw, or other attachment device. In some cases, the counterweight 702 may be placed or located at approximately the same distance from the center 106 of wheel 100 as the reflector 700. In other cases, for example, when the counterweight 702 and the reflector 700 are not the same weight (e.g., varying by a small amount to a more substantial amount), the radial position of the counterweight 702 and/or the reflector 700 may be adjusted to achieve a more balanced wheel.

### Rotational Weight Shifting Wheel

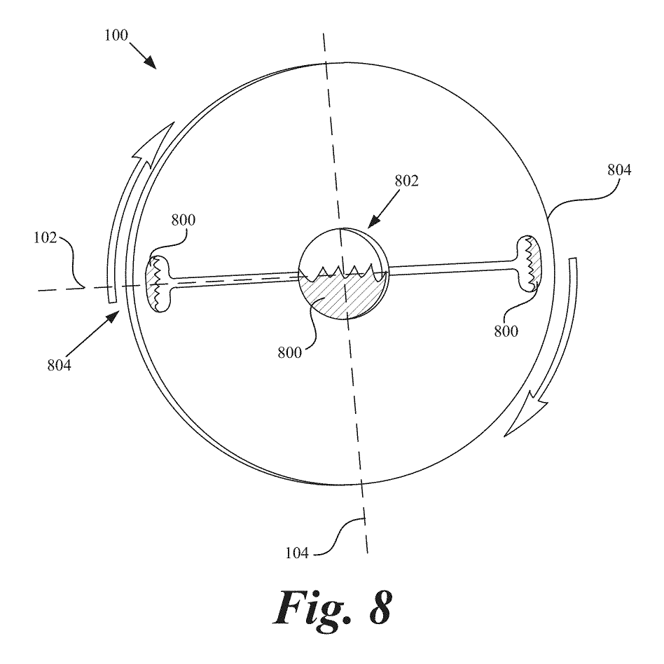

FIG. 8 illustrates another aspect of the present disclosure including a wheel with the ability to weight-shift for optimal performance. When riding a bicycle-type product, lighter wheels can be advantageous for, e.g., climbing an uphill or uneven terrain, while heavier wheels can be advantageous for, e.g., flatter terrain because the additional mass allows the user and/or rider to pick up inertia and momentum. In the example illustrated in FIG. 8, liquid or mechanical weight 800 can be shifted to and from the center 802 of the wheel. When the liquid or mechanical weight 800 is in the center 802 of the wheel, the wheel remains static and lightweight from the perspective of the user (e.g., less force required to accelerate the rotation of the wheel), allowing for optimal performance on uphill and/or uneven terrain. The shifting of weight 800 from the center 802 to or towards the outer wheel 804 causes a “fly wheel” effect, providing the extra mass for the inertia/momentum for the user when on flatter terrain.

The liquid or mechanical weight 800 can be shifted to and from the center 802 of the wheel through a variety of means, including but not limited to a mechanical pump, electrical device and/or motor (not shown here). These devices can be controlled by the user via a mechanism akin to gear shifting, wireless remote or even a small computer programmed in advance to match the terrain of the riding route. This embodiment causes the inertia of the outer rotational weight of the wheel to be “lighter” or “heavier” in response to user preference and selection. In one example, a pump, liquid reservoir and movable liquid could both be located at the center or hub of both front and rear wheels.

### Wheel Yaw Correction

At high speed rotation (e.g., 40 miles per hour), not only do unbalanced wheels vibrate and oscillate, but they also tend to yaw. Alternatively and/or in addition to balancing the weight along the tire, tube, rim, and wheel through the disclosed systems and methods to minimize vibration and oscillation, aspects of the present disclosure can also be implemented to minimize and correct yaw through balancing principles as well as any subsequent versions or improvements thereof.

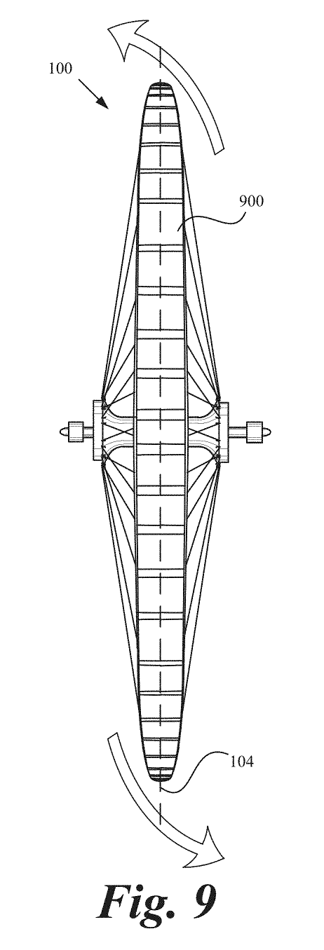

FIG. 9 illustrates a bicycle-type wheel 100 generally divided into a left half and a right half along y-axis 104. If one side is heavier than the other, the imbalance causes the wheel to yaw. Accordingly, during the manufacture/production and assembly process, weights and/or other materials can be added to, for example, the lighter right side of the wheel at a chosen spot 900, in order to obtain optimal balance. The weight can be added to the outside or inside of the rim or tire during the manufacturing process or after the manufacturing process is complete. The location that is optionally advantageous is the one that most easily corrects the yaw. In this embodiment, 30 grams of lead weight is added to the right side of the wheel.

Various methods of controlling, marking, and adding weight to the tires, rims, tubes, and/or wheels during the manufacture and assembly process include the methods previously discussed as well as any subsequent versions or improvements thereof.

Wheels and Tires without Air Valves

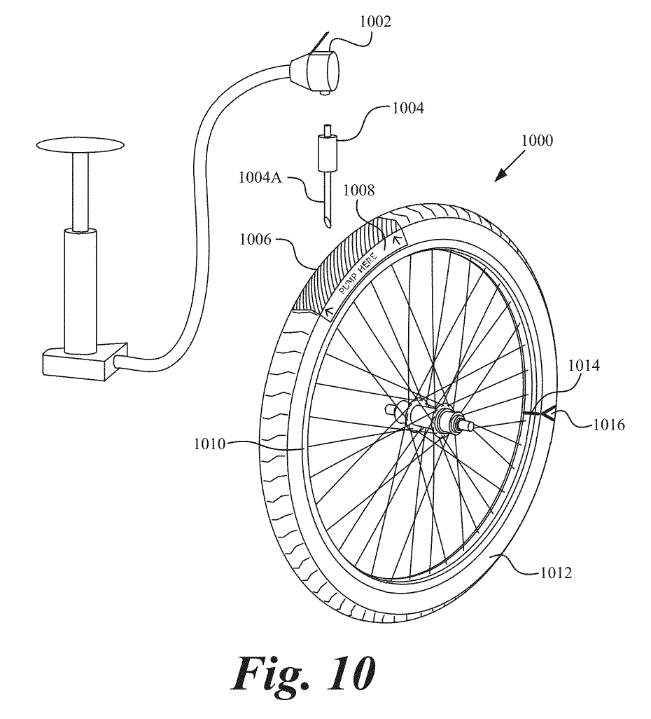

FIG. 10 illustrates yet another aspect of the present disclosure: a tubeless tire/wheel 1000 without a standard air valve. FIG. 10 also illustrates, schematically, an air pump 1002 with a standard air valve 1004, which can be used with aspects of the present disclosure. In some aspects, the air valve can be threaded, Presta, Schrader, French, or other standard (e.g., world standard) air valve. Having a wheel and/or tire without an air valve provides optionally advantageous effects, including but not limited to less weight, less breakage and repairs of the air valve, etc. Rather than an air valve, one section 1006 of the tire 1012 comprises, for example, self-sealing rubber tire material. Similar to other teachings discussed in the present application, this section of self-sealing rubber tire material can be controlled, marked, and assembled during the manufacturing and assembly process.

In this embodiment, the needle 1004A of the air valve 1004 on the air pump 1002 can pierce through any part within the section 1006 of self-sealing rubber tire material on the tire/wheel, indicated by the guidance logo 1008 allowing the user to pump air into the wheel easily and without need of an air valve on the tire/wheel itself. When the tire/wheel is pumped to the desired pressure and/or firmness, the user merely needs to withdraw and remove the air pump air valve needle from the tire/wheel, and the self-sealing rubber tire material will close up.

In some cases, due to the lack of an air valve assembly, the wheel component may be manufactured and/or selected to accommodate for the difference in weight to balance the wheel. For example, the tire heavy spot may be made heavier to accommodate for the lack of weight of the air valve assembly, which as descried above, would be aligned with the tire heavy spot. In yet another example, the rim selected or the manufacture of the rim may be modified to select a lighter coupler 206.

In the example illustrated, both the rim 1010, and the tire 1012 may include markings 1014 and 1016 for aligning the tire 1012 and rim 1010 during assembly to yield an optimally balanced wheel. In one example, the rim marking 1014 may indicate a light spot on the rim 1010 (e.g., opposite a heavy spot resulting from joining the rim together), whereas the tire marking 1016 may indicate a heavy spot of the tire 1012. In this scenario, the markings may be aligned at the same position to yield an optimally balanced wheel (as illustrated). In other examples, the rim marking 1014 may indicate a heavy spot of rim 1010, and may thus be aligned opposite the center of the wheel 1000 from tire marking 1016 to yield an optimally balanced wheel. Other markings or other locations of the tire and rim markings are also contemplated herein.

### Flashing and Warning Signals for Wheel Imbalance

Aspects of the present disclosure can include mechanical, electronic and/or digital mechanisms that monitor the performance and balance of the wheel and system and alert the user when the wheel system is losing its optimal balance and performance. In one embodiment, this is done through detecting the vibration frequency and/or intensity by using a software application on, for example, an iPhone or small Garmin computer device. This detecting device can work on the same principle as a digital musical instrument tuning device.

A wireless application of this aspect can display balance information, yaw information, and/or momentum (weight shifting in the wheel) information on a small computer located on the handlebars of the bicycle or on the inside of the visor or glasses of the rider. Balance and performance may naturally decrease due to a variety of factors, including but not limited to accidents or wear and tear. Thus a constant monitoring device may provide for increases in performance of riders.

One skilled in the art would appreciate that the electronic or digital signals in this embodiment could take the form of, for example, warning lights (green=performing at standard levels; yellow=caution/needs attention; and red=needs to be replaced/repaired), flashing lights (in which frequency of the flash could indicate severity of imbalance or performance), a series of bars akin to signals showing battery life, or any other method, picture or indicator now used or later conceived.

### Additional Aspects

In some aspects, one or more of the above-described systems and methods may be captured by one or more of the following additional concepts. One or more of the following concepts may be combined with one or more other concepts, either listed below or described above, as will be appreciated by one having ordinary skill in the art.

In one aspect, a method of optimizing wheel balance may include: determining a desired weight of a heavy spot on a first wheel component and a second wheel component; measuring the weight of the heavy spot created by the manufacture on the first wheel component and the second wheel component; controlling the weight of the heavy spot by adjusting the weight of the heavy spot until the desired weight is achieved, and arranging and assembling the first wheel component to counter-balance the second wheel component.

In one aspect, a method of optimizing wheel balance prior to assembly a first and second wheel component may include: determining and measure a heavy spot on a first wheel component and a second wheel component; indicating a weight difference between the heavy spot on the first wheel component and the heavy spot on the second wheel component; and marking the heavy spot the first wheel component and the second wheel component.

In one aspect, a system for controlling the weight of a heavy spot on a rim includes: a rim comprising a first end and a second end; a hollow rim joining insert, wherein the hollow rim joining insert fits into the first end and the second end and joins the first end and second end together; a weight, wherein the weight is inserted into the hollow rim joining insert; and an aperture located on the rim directly opposite of the location of the hollow rim joining insert.

In one aspect, a system for controlling the weight of a heavy spot on a rim may include: an unassembled rim having first end and a second end, wherein the first end and second end can be joined together to form an opening with a center; a hollow rim joining insert positioned inside the first end and the second end; and a weight configured to be positioned inside the hollow rim joining insert.

In one aspect, a method for manufacturing a hollow rim may include: placing a circular inflatable air bladder inside a circular mold to form a hollow rim; measuring a position and a weight of the hollow rim to determine a heavy spot on the hollow rim; and affixing an assembly guide logo on the hollow rim aligned with and indicating the position of the heavy spot on the hollow rim.

In one aspect, a method for manufacturing a tire may include: manufacturing a heavy spot, or light spot, or other weight difference on a tire by overlapping at least one tire material to form a tire joint where the tire is connected to form a complete circle; and controlling the desired weight of the heavy spot by at least one of adding or subtracting the amount of at least one tire material located on the tire joint before the tire undergoes a molding process. In some cases, the method may further include affixing an assembly guide logo on the tire in a position aligned with the position of the heavy spot, light spot, and/or other weight difference location of the tire.

In one aspect, a method for manufacturing a tube may include: manufacturing a heavy spot on a tube by affixing a tube valve; and altering the desired weight of the tube valve.

In one aspect, a system for optimally balanced wheel may include: a rim; a tire attached to the rim to create a wheel; a reflector attached to the wheel, wherein the reflector has a weight W1; and a counterweight attached to the wheel directly opposite to the reflector, wherein the counterweight has a weight W2, wherein W1 is equal to W2.

In one aspect, a method for making an optimally balanced wheel, may include: attaching a reflector to a wheel; and attaching a counterweight to the wheel directly opposite to the reflector, wherein the counterweight is of equal weight to the reflector.

In one aspect, a system for a rotational weight shifting wheel may include: a wheel; a first compartment position in the center of the wheel; a second compartment positioned on the outer edge of the wheel, wherein the first compartment and second compartment are connected via a first conduit; a third compartment position on the outer edge of the wheel, wherein the first compartment and third compartment are connected via a second conduit, wherein the second compartment and third compartment are positioned on the wheel to be directly opposite of each other; a fluid material contained in the first compartment; and a pumping mechanism configured to pump the fluid material to and from the first compartment to the second and third compartments.

In one aspect, a method of creating a rotational weight shifting wheel, may include: pumping a fluid material to and from a center compartment and a first outer compartment and second outer compartment, wherein the first outer compartment and second outer compartment are located on a wheel directly opposite of each other.

In one aspect, a method for wheel yaw correction may include locating and marking a heavy spot on a left side or a right side of a wheel; and controlling the weight differences between a left side of the wheel and the right side of the wheel by adding weight directly opposite to the heavy spot. In other cases, light spots or locations or locations having a weight difference may additionally or alternatively be marked and used to correct yaw.

In one aspect, a system for a no air valve tire may include: a tubeless tire; and a section on the tire comprised of self-sealing material, wherein this section is clearly marked.

In one aspect, a system for monitoring and alerting a user to imbalance of a wheel system may include: a means for monitoring the balance of the wheel system; and a means for alerting a user about the balance of the wheel system.

While examples of the present disclosure have been illustrated and described, as noted above, many changes can be made without departing from the spirit and scope of the disclosure. The various embodiments, aspects, and examples described above can be combined to provide further embodiments, aspects, or examples. Aspects can be modified, if necessary, to employ devices, features, methods and concepts of the various patents, applications and publications to provide yet further embodiments.

What is claimed is:

1. A collection of wheel components configured to be assembled into a balanced wheel, the collection of wheel components comprising:
a rim defining an opening and having a center, wherein the rim comprises a first heavy spot and an aperture that are positioned opposite one another about the center, wherein the first heavy spot is associated with a first weight;
a tire having a second heavy spot, wherein the second heavy spot is associated with a second weight, wherein the tire is configured to be assembled with the rim such that the second heavy spot is positioned opposite of the first heavy spot about the center; and
an air valve insertable through the aperture of the rim, wherein the air valve has a third weight, and wherein the first weight is approximately equal to a combination of the second weight and the third weight.

2. The collection of wheel components of claim 1, wherein the air valve is connected to an inner tube configured to be positioned within the tire.

3. The collection of wheel components of claim 1, wherein the air valve comprises a tubeless air valve.

4. The collection of wheel components of claim 1, wherein the rim comprises carbon fiber.

5. The collection of wheel components of claim 1, wherein the tire further comprises a first assembly guide logo aligned with and indicating the position of the second heavy spot.

6. The collection of wheel components of claim 1, further comprising:
a reflector associated with a fourth weight; and
a counterweight configured to be positioned opposite of the reflector about the center, wherein the counterweight is associated with a fifth weight selected to counterbalance the reflector.

7. A collection of wheel components configured to be assembled into a balanced wheel, the collection of wheel components comprising:
a rim defining an opening and having a center, wherein the rim comprises a first heavy spot, wherein the first heavy spot is associated with a first weight; and
a tire having a second heavy spot, wherein the second heavy spot is associated with a second weight, wherein the tire is configured to be assembled with the rim such that the second heavy spot is positioned opposite of the first heavy spot about the center, wherein the first weight is approximately equal to the second weight.

8. The collection of wheel components of claim 1, wherein the rim further comprises a first assembly guide logo aligned with and indicating the position of the first heavy spot.

9. A method for assembling an optimally balanced wheel, the method comprising:
inserting an air valve through an aperture in a rim, wherein the air valve is associated with a third weight, wherein the rim defines an opening with a center, wherein the aperture of the rim is positioned opposite of a first heavy spot of the rim about the center, and wherein the first heavy spot is associated with a first weight; and
mounting a tire having a second heavy spot onto the rim to form an optimally balanced wheel, wherein the second heavy spot is positioned opposite of the first heavy spot about the center, wherein the second heavy spot is associated with a second weight, and wherein the first weight is approximately equal to a combination of the second weight and the third weight.

10. The method of claim 9, wherein the air valve is connected to an inner tube positioned within the tire.

11. The method of claim 9, wherein the air valve comprises a tubeless air valve.

12. The method of claim 9, wherein the rim comprises carbon fiber.

13. The method of claim 9, wherein the tire further comprises a first assembly guide logo aligned with and indicating the position of the second heavy spot.

14. The method of claim 9, wherein the rim further comprises a reflector associated with a fourth weight, wherein the method further comprises:
positioning a counterweight opposite of the reflector about the center to counterbalance the reflector.

15. The method of claim 9, further comprising:
determining a yaw associated with the optimally balanced wheel; and
adjusting a position of at least one of the reflector or the counterweight to correct the yaw.

16. A method of manufacturing a wheel component to be used in a balanced wheel assembly, the method comprising:
determining a first weight associated with a first heavy spot of a first wheel component;
determining a second weight associated with a second heavy spot of a second wheel component based on the first weight; and
manufacturing the second heavy spot on the second wheel component at a position.

17. The method of claim 16, further comprising:
marking the position of the second heavy spot on the second wheel component.

18. The method of claim 16, wherein the first wheel component comprises a tire, and the second wheel component comprises a rim.

19. The method of claim 18, wherein manufacturing the second heavy spot on the second wheel component at the first position comprises:
selecting a rim joining insert having a weight approximately equal to the second weight; and
inserting the rim joining insert into the rim at the first position, wherein the rim is joined at the first position.

20. The method of claim 16, wherein the first wheel component comprises a rim, and the second wheel component comprises a tire.

21. The method of claim 20, further comprising:
determining a third weight associated with a third wheel component; and
determining the second weight associated with the second heavy spot of the second wheel component based on the first weight and the third weight.

22. The method of claim 21, wherein the third wheel component comprises an air valve.

23. The method of claim 21, wherein determining the second weight based on the first weight and the third weight comprises determining the second weight to be approximately equal to a combination of the first weight and the third weight.
